(19) United States
(12) Patent Application Publication
(10) Pub. No.: US 2003/0121695 A1
(43) Pub. Date: Jul. 3, 2003

(54) Local area network cabling arrangement utilizing corrugated tapes

(76) Inventors: Dave A. Wiebelhaus, Omaha, NE (US); Daniel J. Parke, Omaha, NE (US); Bruce Clark, Winder, GA (US); John Milsaps, Buford, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/038,641

(22) Filed: Jan. 2, 2002

(51) Int. Cl. H01B 7/00

(52) U.S. Cl. 174/116

(57) ABSTRACT

An electrical cable having a plurality of twisted pairs of conductors therein and a corrugated tape member that separates and maintains spacing of said twisted pairs from adjacent twisted pairs. The corrugated tape member is preferably comprised of a dielectric material and said corrugation may be longitudinal or across the width of said tape member. The corrugated tape member permits the use of a thinner mil tape while achieving sufficient spacing between the twisted pairs and maintaining cable flexibility so as to significantly improve crosstalk and reduce manufacturing costs and difficulties associated with thicker mil flat tape or fluting.

### FIELD OF THE INVENTION

The invention relates to electrical cabling. More particularly, the invention relates to reducing crosstalk in electrical cabling by effectively increasing the spacing for optimum pair separation. Moreover, pair separation is achieved by inducing a corrugated configuration into a bisector tape.

### BACKGROUND OF THE INVENTION

In the communication industry, the reduction of crosstalk in electrical cables is an ongoing problem. Often an electrical cable will contain a plurality of twisted pairs of individually insulated conductors. In the past, many configurations and techniques have been implemented to reduce crosstalk between the respective electrically conducting pairs.

For example, one of the most useful techniques for reducing crosstalk within electrical cabling includes physically separating the twisted pairs within the cable. In this manner, numerous components such as spacer elements, flat bisector tapes, convex tapes, crosswebs or other filler elements have been used to increase pair separation and improve crosstalk. See, e.g., U.S. Pat. Nos. 4,920,234 and 5,149,915. Because typical communications industry electrical cables include four twisted pairs, many spacer element configurations comprise one or more centrally-located spacer elements, such as a dielectric flute, with the twisted pairs arranged in various configurations therearound. See, e.g., U.S. Pat. Nos. 5,132,488 and 5,519,173.

However, these methods and cable arrangements aimed at reducing crosstalk are often burdened with other problems. For example, existing spacer elements are relatively inflexible and thus restrict movement of the twisted pairs within the electrical cable. Also, existing spacer elements are relatively expensive and difficult to handle and manipulate during the electrical cable manufacturing process.

One simple way in which the spacing can easily be increased between twisted pairs is the addition of more material. In this regard, the thickness of the tape is increased to a desired thickness and/or stiffness. However, simply increasing the thickness of the tape often has negative implications, such as over-stiffening the tape, degrading the burn performance of the cables by the addition of too much material, or significantly increasing the cost of manufacturing the cables.

Efforts to improve the crosstalk performance of cables have generally involved incorporating additional separation between pair units. This additional separation is achieved and maintained with the use of flat, cross-shaped or semi-circled tape or flutes between or around the twisted pair units. Some manufacturers may also jacket one or more of the pair cables and then surround the jacketed cables with another jacket in particularly large cables, such as 25 pair LAN cables. These methods of inducing increased separation between pair units introduce an additional cost factor, inflexibility and manufacturing complexity into the electrical cables.

Thus, a heretofore unaddressed need exists in the industry to have electrical cabling that addresses the aforementioned deficiencies and inadequacies.

### SUMMARY OF THE INVENTION

The present invention is embodied in an electrical cable having a plurality of twisted pairs. In one example embodiment, the cable has four (4) twisted pairs, although it is to be understood that the invention can be used with other numbers of twisted pairs. The cable is configured to have four twisted pairs with a corrugated tape separating at least two of the twisted pairs from the other twisted pairs. The corrugation of the tape comprises shaping the tape into folds of parallel and alternating ridges and grooves. A longitudinal tape runs the length of the cable so as to separate and maintain at least one or more of the twisted pairs from the remaining twisted pairs that are adjacent thereto.

The tapes may be comprised of, for example, polypropylene (PP), fire retardant polypropylene (FRPP), or low-smoke polypropylene (LSPP), or any other suitable material and may be comprised of varying thicknesses. In one example embodiment, the corrugated tape is comprised of LSPP having a thickness of approximately 8 to approximately 12 mils and a width of approximately 0.12 to approximately 0.40 inches. However, other suitable materials, thicknesses and widths may also be used. Along the longitudinal direction of the tape, corrugating of the tape is provided to increase the spacing and stiffness properties of the tape without substantially increasing the amount of material used in the manufacture of the tape. In one embodiment, the length of the corrugation from ridge peak to ridge peak along the longitudinal direction of the tape should be less than approximately 0.12 inches. In this manner, the effective spacing between the twisted pairs is optimized for improved crosstalk performance and satisfaction of fire safety requirements.

In another example embodiment of the invention, the tape is corrugated across its width such that the spacing and stiffness properties of the tape are increased without increasing the linear amount of material used in the manufacture of the tape. For one embodiment of the tape corrugated across its width, an initial sufficient width of tape should be used, such that once corrugated, the width corrugated tape has a final width of approximately 0.12 to approximately 0.40 inches. In one embodiment, the length of the corrugation from ridge peak to ridge peak for corrugation across the width of the tape should be less than approximately 0.06 inches. In this manner, the effective spacing between the twisted pairs is optimized for improved crosstalk performance and satisfaction of fire safety requirements.

In all of the embodiments of the present invention, the flexibility of the cable is maintained with the corrugated tape in place, and substantial improvement in the minimum power sum crosstalk margin is realized. The corrugated separator tape can be made of various materials so long as appropriate care in the selection thereof is taken. In the case where a fire retardant cable is desired, the use of a corrugated tape can provide a sufficient mil spacing so as to meet certain electrical requirements, while simultaneously reducing the amount of tape material normally required by a flat tape to achieve equivalent electrical specifications. In this regard, the amount of tape material is sufficiently reduced so that the bum test of the cable is satisfied by using a corrugated tape of a smaller mil than would be satisfied by using a flat tape equivalent to the thickness of the dimensions of the corrugated tape.

Other systems, methods, features, and advantages of the present invention will become apparent to one with skill in the art upon examination of the following drawings and detailed description. It is intended that all such additional systems, methods, features, and advantages be within the scope of the present invention, and be protected by the claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cross-sectional view of a prior art four pair cable with a cross shaped spacer;

FIG. 2 is a cross-sectional view of a prior art four pair cable with a semi-circled shaped spacer;

FIG. 3 is a side view of a length of corrugated tape;

FIG. 4 is a cross-sectional view of a cable incorporating the corrugated tape as a spacer between twisted pairs;

FIG. 5 is a perspective, break out view showing the longitudinal corrugation of the tape in an electrical cable;

FIG. 6 is a cross-sectional view of a cable showing another embodiment of the invention in which the tape is corrugated along its width; and

FIG. 7 is a perspective, break out view showing the width corrugation of the tape in an electrical cable.

### DETAILED DESCRIPTION

Electrical cabling such as that used in communication networks continues to suffer adversely from the reactive effects of parallel and adjacent conductors, i.e., inductive and capacitive coupling, also known as “crosstalk.” Typically, electrical cabling includes a jacket containing a plurality of twisted pairs of individually insulated conductors. As the number of twisted pairs within an electrical cable increases and/or the twisted pairs are placed closer together, the potential for crosstalk interference increases.

Crosstalk becomes more severe at higher frequencies, at higher data rates, and over longer distances. Thus, crosstalk effectively limits the useful frequency range, bit rate, cable length, signal to noise (S/N) ratio and number of conductor pairs within a single electrical cable for signal transmission. Additionally, crosstalk is often more pronounced in bidirectional transmission cables. Such effect is known as “near end crosstalk” (NEXT), and is particularly noticeable at either end of the cable where signals returning from the opposite end are weak and easily masked by interference.

In general, crosstalk is better controlled by separating parallel and adjacent transmission lines or by transposing the signals along the cable to minimize the proximity of any two signals. However, one of the easiest ways to reduce crosstalk involves increasing the amount of space or separation between the twisted pairs in the cable. As the spacing increases, the severity of the crosstalk decreases a calculable amount.

Accordingly, as shown and discussed herein, many electrical cable arrangements exist that include spacer elements for maintaining sufficient separation between the conducting pairs and thus reducing crosstalk therebetween.

Referring now to FIG. 1, shown is a prior art electrical cable 20 having an arrangement aimed at reducing crosstalk. The electrical cable 20 comprises a jacket 12, made of a suitable polymeric material, surrounding four pairs of individually insulated conductors or conductive elements 14 separated by a spacer 16. The individually insulated conductor pairs 14 are typically comprised of twisted pairs of copper wire or fiber optic material, and the spacer 16 is typically comprised of a suitable dielectric material such as polyvinyl chloride (PVC).

In operation, the spacer means 16 separates the conductor pair 14 and maintains substantially constant spacing between the conductor pairs 14 along the length of the electrical cable 20. In this manner, the separation of the conductor pairs 14 results in increased crosstalk performance.

Although conventional spacer 16 and conductor pairs 14 arrangements may reduce crosstalk to a certain degree, many of these conventional cable arrangements are often burdened with other problems, as discussed previously herein. For example, many spacers 16 are relatively inflexible and thus restrict movement of the conductor pairs 14 within the electrical cable 20. Also, the inflexibility of the spacer 16 makes it difficult to handle and incorporate into electrical cables 20 during manufacturing. Furthermore, many spacers 16 are relatively expensive and contribute significantly to the overall cost of the cable 20. The expense of the spacer 16 is particularly important when, in order to satisfy certain electrical requirements, the thickness of the spacer 16 must be increased to provide sufficient separation between the conductor pairs 14. Additionally, the increase in the thickness or amount of material in the spacer 16 may cause the cable 20 to fail fire safety requirements. This is particularly applicable for cables that must meet plenum (CMP) and/or Nonhalogen IEC 60332 Part 3C fire safety ratings.

Referring now to FIG. 2, a prior art electrical cable 20 is shown in which the electrical cable 20 includes a jacket 12 formed around a plurality of pairs of individually insulated conductors or conductive elements 14, typically four pairs, as shown. The jacket 12 is made of any suitable flexible, electrically insulating material, e.g., a fluoropolymer, polyvinyl chloride (PVC), a polymer alloy or other suitable polymeric material. The conductor pairs 14, which are typically twisted pairs of copper wire or fiber optic material, are individually insulated with a suitable polymeric material, e.g., polyolefin, flame retardant polyolefin, fluoropolymer, PVC or a polymer alloy.

As shown in FIG. 2, it is known in the prior art to maintain the spacing between the conductor pairs 14 by a dielectric film or tape 22 advantageously positioned around particular conductor pairs 14. The dielectric film 22 is comprised of a suitable electrically insulating material, such as Kapton® film (polyamide) woven glass yarn tape, ethylchlorotrifluoroethylene (ECTFE or Halar®), polyvinyl chloride (PVC), polyolefins and fluoropolymers including fluorinated ethylene-propylene (FEP or Teflon®), perfluoroalkoxy polymers of tetrafluoroethylene and either perfluoropropyl ether (PFA) or perfluoromethylvinyl ether (MFA). The thin dielectric film 22 has a flexible construction that does not significantly affect the flexibility of the electrical cable 20. However, the placement of the semi-circular configured dielectric film 22 around alternating conductor pairs 14 (e.g. the first and third pairs) is advantageous in that it reduces crosstalk by maintaining separation between the conductor pairs 14. In this manner, the spacing between adjacent conductor pairs 14 is substantially constant along the length of the cable and the conductor pairs 14 are separated to the extent that the conductor pairs generally occupy separate quadrants within the electrical cable 20.

FIG. 3 depicts a side view of a corrugated tape 30 in accordance with a first example embodiment of the present invention. In this regard, it is shown that a bisector tape 30 is corrugated as opposed to being a flat tape. The bisector tape 30 preferably is comprised of a material that is amenable to corrugation, i.e., shaping into folds of parallel and alternating ridges and grooves. The corrugation length 31 is defined as the distance from ridge peak to ridge peak. In this manner, the corrugated tape 30 achieves an effective thickness 32 that exceeds the actual thickness 34 of the tape material itself. This effective thickness 32 allows a manufacturer to use a smaller mil of tape material and still achieve a degree of separation that would have been achieved using a thicker mil tape. The ability to use a smaller mil tape to achieve a larger effective thickness 32 is beneficial in that it utilizes significantly less material than achieving the same thickness by increasing the actual thickness 34 of the tape. The use of less material to achieve the same separation of the conductor pairs 14 results in savings in manufacturing costs and does not degrade the burn performance of the cable 20.

For example, if the electrical requirements of an electrical cable 20 require a 15 mil spacing between the conductor pairs 14, but the cable 20 is failing the fire safety burn test because of the thickness of the bisector tape, the corrugated tape 30 may be used. In this respect, a 10 mil tape, which would pass the burn test, is corrugated to a 15 mil specification or effective thickness 32. Thus, a corrugated 10 mil tape can be used in place of the 15 mil tape, thereby saving material costs and satisfying the fire safety bum tests.

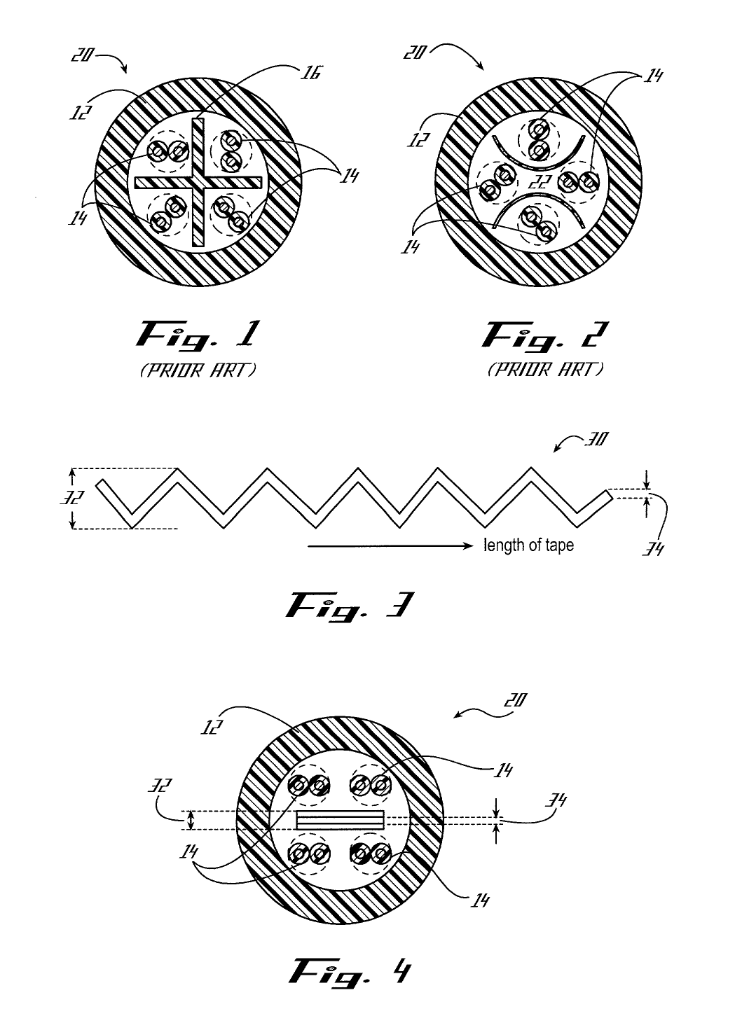

As shown in FIG. 4, in cross-section, the longitudinally corrugated bisector tape 30 appears as a separator, spacing two conductor pairs 14 in a typical four pair cable 20 from the other two conductor pairs 14 in this example. In FIG. 5, the perspective view of an electrical cable containing a longitudinally corrugated bisector tape 30 is shown. The corrugation extending along the length of the bisector tape 30 increases the actual thickness 34 of the bisector tape 30 to an effective thickness 32 in order to separate and maintain two pairs of conductors 14 from the remaining two pairs of conductors 14. Additionally, the corrugation increases the stiffness across the tape 30, adding to the stability of the tape and the maintenance of the degree of separation of the pairs of conductors 14. It is anticipated, however, that the stiffness of the corrugated tape 30 is such that the tape 30 is capable of bending or flexing along either its length or width, thus permitting the tape 30 and the electrical cable into which it is incorporated to be bent or flexed if desired. In this manner, the spacing of the conductor pairs 14 effectively reduces crosstalk and increases crosstalk performance as measured on a decibel (db) per dollar basis for the costs associated with the tape.

The corrugated bisector tape 30 preferably extends the length of the conductor pair units 14 in the length of the electric cable 20. The tape 30 may include any of a number of materials such as flexible, dielectric materials (including, for example, polypropylene tape, a polyimide woven glass yarn tape, such as Kapton®, polyvinyl chloride, or any of several polyolefins and/or fluoropolymers, or any of several other insulating materials, including fire retardant materials, such as fire retardant polypropylene), or any other suitable material. In a preferred embodiment, the corrugated tape 30 is comprised of LSPP having a thickness of approximately 8 to approximately 12 mils, a width of approximately 0.12 to approximately 0.40 inches, and a corrugation length 31 of approximately 0.12 inches from ridge peak to ridge peak.

The corrugated tape 30, by maintaining the separation between adjacent twisted pairs 14, has been found to be an economically advantageous mechanism of reducing crosstalk in a cable structure. Additionally, the suppleness of the tape 30 allows it to flex easily when, for example, the cable 20 is bent or twisted. However, the corrugation also provides stiffness across the tape 30 such that its strength properties are increased, which, in turn, increases the strength properties of the cable. Furthermore, if increased separation between adjacent pairs 14 is desired, more than one corrugated tape 30 may be used in the cable 20. For instance, two corrugated tapes 30 may be used to achieve separation between each of a four, twisted pair cable 20. Additionally, one or more corrugated tapes 30 may be used in a cable 20 in combination with other types of tapes or separating devices as are known and used in the art, in order to achieve desired electrical performance and characteristics. It has further been found that the electrical performance of the cables of the invention, as depicted in FIGS. 4-7, compares favorably with electrical cables of the type shown in FIGS. 1 and 2, as well as others, with the added advantages of flexibility and economy of fabrication.

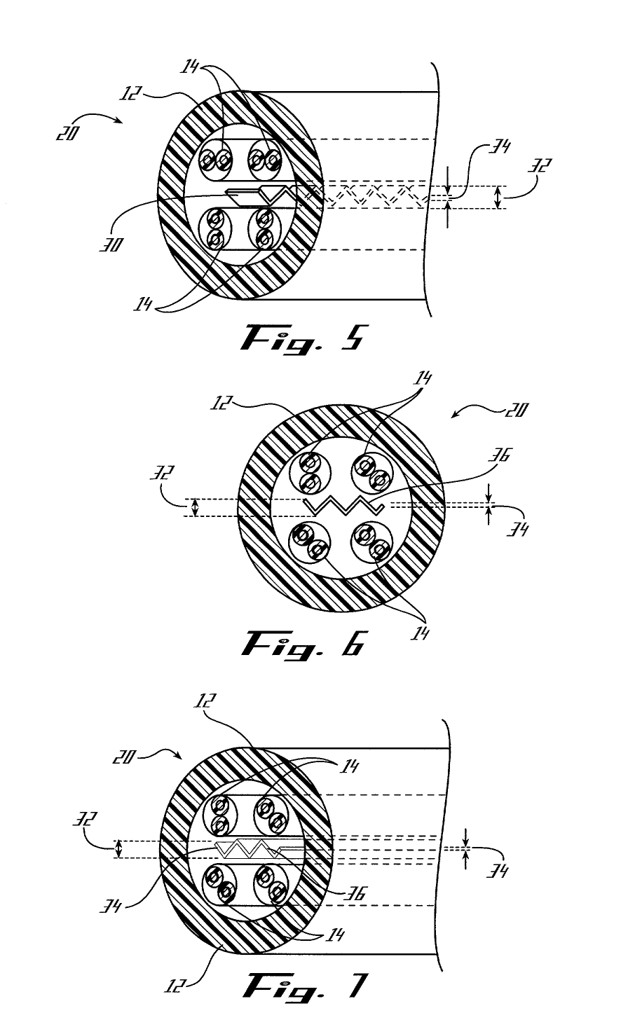

In accordance with another example embodiment of the invention shown in FIGS. 6-7, the corrugation of the bisector tape 36 is configured across the width of the tape. In this respect, the corrugated tape 36 still maintains the increased effective thickness 32 without increasing the actual thickness 34 of the tape 36, thus resulting in an overall reduction in the amount of spacing materials necessary to achieve certain electrical requirements. This width corrugating embodiment also maintains the strength and stiffness properties that were discussed above with respect to the longitudinal corrugation. In addition to the overall reduction of spacing materials, the width corrugated tape 36 offers the added benefit of manufacturing ease, because the length of tape 36 necessary to run the length of the conductive pairs 14 of the cable 20 does not require adjustment for the loss of length due to longitudinal corrugation.

The embodiment of the invention depicted in FIGS. 6-7 is, except for the direction of corrugation of the bisector tapes 30 and 36 and a corrugation length 31 of approximately 0.06 inches from ridge peak to ridge peak, substantially similar to that shown in FIGS. 4-5. More particularly, the operative results are substantially the same, i.e., advantageously providing economics of manufacture, greater flexibility in spacing design, and optimization of separation and maintenance of spacing between conductor pairs 14 for increased crosstalk performance.

It should be emphasized that the above-described embodiments of the present invention, are only possible examples of implementations, merely set forth for a clear understanding of the principles of the invention. Many variations and modifications may be made to the above-described embodiment of the invention without departing substantially from the spirit and principles of the invention. All such modifications and variations are within the scope and the present invention.

1. An electrical cable comprising
a plurality of longitudinally extending twisted pairs of conductive elements;
at least one corrugated tape member separating at least one of said twisted pairs of conductive elements from an adjacent one of said twisted pairs of conductive elements, wherein the corrugated tape member separates and maintains spacing between twisted pairs separated by said at least one corrugated tape member; and
a dielectric jacket surrounding and enclosing the plurality of twisted pairs.

2. An electrical cable as claimed in claim 1, wherein said cable comprises four twisted pairs and the corrugated tape member separates two of the twisted pairs from the remaining two twisted pairs.

3. An electrical cable as claimed in claim 1, wherein said cable comprises more than one corrugated tape member.

4. An electrical cable as claimed in claim 1, wherein said cable comprises at least one corrugated tape member and at least one other means for separating and maintaining spacing between twisted pairs.

5. An electrical cable as claimed in claim 1, wherein the corrugated tape member is comprised of a flexible, dielectric material.

6. An electrical cable as claimed in claim 5, wherein the corrugated tape member is comprised of one or more materials selected from the group consisting of polypropylene tape, polyamide woven glass, polyvinyl chloride, one or more polyolefins, and one or more flouropolymers.

7. An electrical cable as claimed in claim 1, wherein the corrugated tape member is configured to have a width of approximately 0.12 inches to approximately 0.40 inches.

8. An electrical cable as claimed in claim 1, wherein the corrugated tape member is configured to have a thickness of approximately 8 mils to approximately 12 mils.

9. An electrical cable as claimed in claim 1, wherein the corrugated tape member is longitudinally corrugated along a length of the tape and said longitudinally corrugated tape extends along a length of the twisted pairs separated by the corrugated tape and along a length of said electrical cable.

10. An electrical cable as claimed in claim 9, wherein the longitudinal corrugations comprise a series of ridges and grooves having a corrugation length, measured from a first ridge to a second ridge, and said corrugation length being approximately 0.12 inches.

11. An electrical cable as claimed in claim 1, wherein the corrugated tape member is corrugated across a width of the tape and, and wherein the width corrugated tape extends along a length of the twisted pairs separated by the tape and along a length of said electrical cable.

12. An electrical cable as claimed in claim 11, wherein the corrugations across the width of the tape comprise a series of ridges and grooves having a corrugation length, measured from a first ridge to a second ridge, and said corrugation length being approximately 0.06 inches.

13. An electrical cable as claimed in claim 1, wherein a plurality of tape members are incorporated into said cable for separation of said twisted pairs and at least one of said tapes is a corrugated tape member.

14. An electrical cable as claimed in claim 1, wherein a corrugated tape member is supplied for separating at least one of said twisted pairs from a remainder of the twisted pairs and wherein said tape member is corrugated so as to have an effective thickness that exceeds an actual thickness of said tape member.

15. An electrical cable as claimed in claim 14, wherein said corrugated tape member provides a spacing of said twisted pairs that equals or exceeds a spacing achieved by a flat tape member having an equivalent actual thickness of material as the corrugated tape member.

16. An electrical cable as claimed in claim 1, wherein said corrugated tape member comprises a fire retardant polypropylene material.

17. A tape member for incorporation in an electrical cable to separate twisted pairs of conductive elements contained therein, comprising:
a length of tape member configured along a length of said twisted pairs and a length of said electrical cable; and
a plurality of corrugations configured into said tape member.

18. An electrical cable as claimed in claim 17, wherein the corrugated tape member is configured to have a width of approximately 0.12 inches to approximately 0.40 inches.

19. An electrical cable as claimed in claim 17, wherein the corrugated tape member is configured to have a thickness of approximately 8 mils to approximately 12 mils.

20. A tape member as claimed in claim 17, wherein said plurality of corrugations are longitudinally configured into said tape member.

21. An electrical cable as claimed in claim 20, wherein the longitudinally configured corrugations comprise a series of ridges and grooves having a corrugation length, measured from a first ridge to a second ridge, and said corrugation length being approximately 0.12 inches.

22. A tape member as claimed in claim 17, wherein said plurality of corrugations are configured across a width of said tape.

23. An electrical cable as claimed in claim 22, wherein the corrugations across the width of the tape comprise a series of ridges and grooves having a corrugation length, measured from a first ridge to a second ridge, and said corrugation length being approximately 0.06 inches.

24. A tape member as claimed in claim 17, wherein at least one said corrugated tape member is provided within said electrical cable for separating at least one of said twisted pairs of conductive elements from adjacent twisted pairs of conductive elements, and wherein the corrugated tape member separates and maintains spacing between said twisted pairs.

25. A tape member as claimed in claim 17, wherein said corrugated tape member separates two twisted pairs from two remaining twisted pairs in a four twisted pair electrical cable.

26. A tape member as claimed in claim 20, wherein said longitudinally corrugated tape member separates at least one of said twisted pairs from a remainder of twisted pairs and said tape member is corrugated so as to have an effective thickness that exceeds an actual thickness of said tape member.

27. A tape member as claimed in claim 20, wherein said corrugated tape member provides a spacing of said twisted pairs that equals or exceeds a spacing achieved by a flat tape member having an equivalent actual thickness of material as the corrugated tape member.

28. A tape member as claimed in claim 17, wherein the corrugated tape member is comprised of a flexible, dielectric material.

29. A tape member as claimed in claim 17, wherein the corrugated tape member is comprised of one or more materials selected from the group consisting of polypropylene tape, polyamide woven glass, polyvinyl chloride, one or more polyolefins, and one or more flouropolymers.

30. A tape member as claimed in claim 17, wherein said corrugated tape member comprises a fir e retardant polypropylene material.
